(19) United States
(12) Patent Application Publication
(10) Pub. No.: US 2011/0139031 A1
(43) Pub. Date: Jun. 16, 2011

(54) CONNECTION MECHANISM AND METHODS FOR CONVERTIBLE RAILWAY-ROADWAY SYSTEMS

(76) Inventors: Ernest J. Larson, JR., Eden Prairie, MN (US); Roger D. Sims, Munster, IN (US); Daniel R. Schneider, East Dubuque, IL (US); Daniel J. Schuller, Dubuque, IA (US); Anthony J. Davis, Cuba City, WI (US); Wyatt Compton, Garretson, SD (US)

(21) Appl. No.: 12/674,285

(22) PCT Filed: Aug. 22, 2008
(86) PCT No.: PCT/US08/73995

§ 371 Date: Feb. 19, 2010

(51) Int. Cl. B61F 13/00; B62D 33/04; B23P 11/00

(52) U.S. Cl. 105/215.2; 296/182.1; 29/401.1

(57) ABSTRACT

Devices, systems, and methods for connecting a rail bogie to a bimodal hauling vehicle and converting the vehicle for use over either a railway or roadway are disclosed. An illustrative system for connecting a rail bogie to a bimodal hauling vehicle includes a receiver unit coupled to the vehicle. A king pin and bogie locking mechanism on the receiver unit can be used to releasably secure the rail bogie to the receiver unit during transitioning of the vehicle from a highway mode of operation to a railway mode of operation. The bogie locking mechanism can include a number of lock jaw members and a lock jaw actuator, which can be engaged to actuate the lock jaw members between an unlocked position and a locked position about a number of locking pins on the rail bogie frame.

### CROSS-REFERENCE TO RELATED APPLICATION

This application claims the benefit of U.S. Provisional Application No. 60/965,716, filed Aug. 22, 2007, which is incorporated herein by reference in its entirety.

### TECHNICAL FIELD

The present invention relates generally to bimodal hauling vehicles for use on both railways and roadways, and to methods for converting such vehicles for use over a railway. More specifically, the present invention pertains to devices, systems, and methods for connecting a rail bogie to a bimodal hauling vehicle.

### BACKGROUND

Various roadway-railway systems have been developed which utilize bimodal or intermodal hauling vehicles capable of conversion from highway use to railway use for reducing the time, labor, and cost associated with transporting freight. In some applications, for example, a bimodal hauling vehicle such a highway tractor trailer can be converted for railway use at a grade crossing or other desired location to facilitate point to point delivery of freight. In many areas, such as rural locations and developing countries, railway transport is often a more cost effective means of ground transport than roadways, and provides several environmental and societal benefits including reduced fuel emissions, noise, road congestion, and highway wear and tear. Estimates from the Environmental Protection Agency (EPA), for example, have found that for every ton mile of transport, a locomotive emits three times less nitrogen oxides and particulates than a typical highway truck, and in some cases can reduce greenhouse gas emissions by 66% or more. The fuel and operating costs associated with transport over a railway is also considerably less than that typically associated with highway transport.

The conversion of a bimodal hauling vehicle for use over a railway requires the connection to a rail bogie which supports the vehicle over the rails, and which can be used to connect the vehicle to another consist. In some applications, multiple bogie mechanisms may be utilized to convert a series of vehicles for use over a railway. An example bogie coupling system for converting multiple railway-roadway vehicles is described in U.S. Pat. No. 5,826,517 to Larson et al., which is incorporated herein by reference in its entirety.

Typical for such systems, the vehicle includes an adjustable suspension system that can be used to actuate the vehicle between a highway mode of operation, a transition mode of operation, and a railway mode of operation. In the highway mode of operation, the suspension system is located in a normal operating position in which the suspension functions as a typical trailer suspension system. The transition mode of operation, in turn, is used to load the vehicle onto the rail bogie. In some systems, for example, the loading can be accomplished by pneumatically raising a number of air bags or air springs provided as part of the suspension system for the vehicle. Once the vehicle is loaded onto the rail bogie, the system is then converted to the railway mode of operation in which a portion of the trailer suspension system and wheels are lifted and locked into position under the vehicle to permit sufficient clearance between the wheels and the railway. A reverse procedure can then be employed to decouple the vehicle from the rail bogie and convert the vehicle back for use in the highway mode.

There are several technical challenges associated with connecting the rail bogie to the vehicle and converting the vehicle between the highway and railway modes. In some cases, significant modifications to the vehicle structure and suspension system may be required in order to convert the vehicle for use over a railway. In those systems that use the vehicle suspension system to lift the vehicle relative to the rail bogie, for example, modifications to the air bags or air springs may be required in order to accommodate the additional vertical travel required to raise the vehicle.

### SUMMARY

The present invention pertains to devices, systems, and methods for connecting a rail bogie to a bimodal hauling vehicle. An illustrative system includes a rail bogie adapted to support the vehicle over a railway, and a receiver unit coupled to the vehicle and including a posterior opening that receives the leading end of a frame the supports the rail bogie. The receiver unit opening can include a flared guiding member which, during insertion of the leading end of the frame into the receiver opening, causes the frame to initially deflect upwardly a distance within an interior space of the receiver unit. A number of contoured guiding members are configured to guide the leading end of the frame into position within the interior space of the receiver unit. In some embodiments, for example, one or more vertical guiding members within the receiver unit are adapted to align the rail bogie frame in a substantially horizontal position adjacent to a bottom section of the receiver unit. A number of lateral guiding members, in turn, are adapted to align a lock block on the rail bogie frame with the king pin.

The receiver unit can further include a king pin and bogie locking mechanism for use in releasably securing the rail bogie to the receiver unit. The bogie locking mechanism can include a number of lock jaws that can be actuated by movement of a locking lever mechanism to engage a number of locking pins on the rail bogie frame. Each of the lock jaws can include a stationary jaw member, a pivoting jaw member pivotally coupled to the stationary jaw member via a pin, and a lock jaw actuator coupled to the locking lever mechanism. When the locking pins are inserted within the lock jaw members, a locking lever may be engaged by the operator, causing lock jaw actuator to translate linearly within a guide track on the stationary jaw member. This causes the pivoting jaw member to pivot about the pin and grip the locking pins, thus rigidly coupling the rail bogie to the vehicle. A reverse process can be performed by the operator to release the grip on the locking pins to permit the rail bogie to be detached from the vehicle, if desired.

An illustrative method of converting a hauling vehicle for use over a railway can include inserting the leading end of the rail bogie frame into the opening of the receiver unit, engaging the king pin within a lock block on the rail bogie frame, adjusting the height of a portion of the rail bogie relative to the receiver unit to align the locking pins vertically within an opening of the lock jaws, actuating the bogie locking mechanism to a locked position about the locking pins, raising the rail bogie above the ground and moving the hauling vehicle and rail bogie onto a railway, and lowering the rail bogie onto the railway.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a side view of a bimodal hauling vehicle in accordance with an illustrative embodiment;

FIG. 2 is a view showing the air ride suspension bag and axle lift air bags forming part of the suspension system for the vehicle of FIG. 1;

FIG. 3 is a bottom view of the hauling vehicle of FIG. 1;

FIG. 4 is a view showing the lever stop mechanism of FIG. 3 in greater detail;

FIG. 5 is a view showing the lockbar support coupled to one of the tandem wheel axles of FIG. 1;

FIGS. 6A-6B are side views of the hauling vehicle of FIG. 1, showing the lockbar lever actuated between an unlocked position and a locked position;

FIG. 7 is a bottom view of an illustrative receiver unit configured for use in releasably securing the vehicle of FIG. 1 to a rail bogie;

FIG. 8 is a top view of the receiver unit of FIG. 7;

FIG. 9 is a rear view showing the receiver unit coupled to the vehicle of FIG. 1;

FIG. 10 is an assembly view showing the configuration of one of the lock jaws depicted in FIGS. 6-8;

FIGS. 11A-11B are several views showing the actuation of the locking lever mechanism and one of the lock jaws in greater detail;

FIG. 12 is a view of another illustrative embodiment of the locking lever mechanism;

FIG. 13 is a view of an illustrative rail bogie for use in supporting the vehicle of FIG. 1 over a railway;

FIG. 14 is an assembly view of the rail bogie of FIG. 13;

FIG. 15 is a top view of the bogie spine frame of FIG. 13;

FIG. 16 is a bottom view of the bogie spine frame of FIG. 13;

FIG. 17 is a top view of the bogie swing frame of FIG. 13;

FIG. 18 is a bottom view of the rail bogie of FIG. 13;

FIG. 19 is a top view of the railway suspension assembly of FIG. 13;

FIGS. 20A-20H are several diagrammatic views illustrating a sequence of steps for converting the vehicle of FIG. 1 for use over a railway using the rail bogie of FIG. 13;

FIGS. 21A-21B are several views showing the attachment of the receiver unit king pin within the lock block of the bogie spine frame;

FIGS. 22A-22B are several views showing the engagement of the lock pins within the jaw members of the receiver unit;

FIGS. 23A-23B are several views showing the lock pin in a disengaged position within the pin lock block of the bogie swing frame; and

FIGS. 24A-24B are several views showing the lock pin in an engaged position within the pin lock block of the bogie swing frame.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

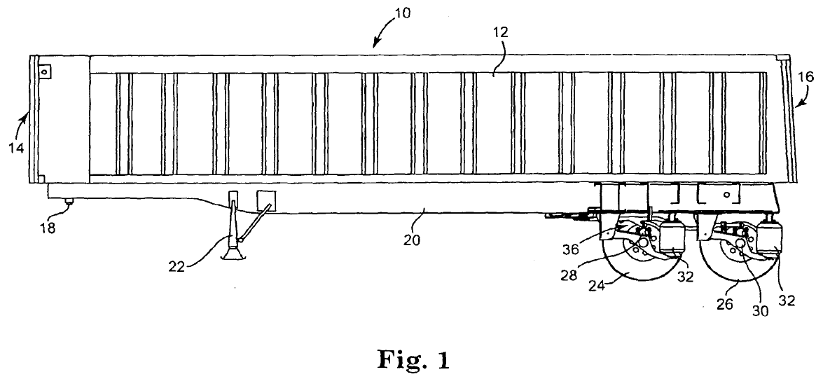

FIG. 1 is a side view of a bimodal hauling vehicle 10 in accordance with an illustrative embodiment. The hauling vehicle 10, illustratively an end-dump tractor trailer, includes a main body 12, an anterior section 14, and a posterior section 16. The anterior section 14 of the vehicle 10 includes a king pin 18 coupled to a bottom support frame 20, which can be used for connecting the vehicle 10 to the fifth wheel hitch of a semi-truck or tractor to permit the vehicle 10 to be used over a highway. A landing gear mechanism 22 coupled to the support frame 20 and extending below the main body 12 of the vehicle 10 can be used for supporting the anterior section 14 of the vehicle 10 in a leveled position when the vehicle 10 is detached from the semi-truck or tractor, as shown. Actuation of the landing gear mechanism 22 between an extended position and a retracted position can be accomplished, for example, via a hand crank, ball valve switch, or other suitable actuation means.

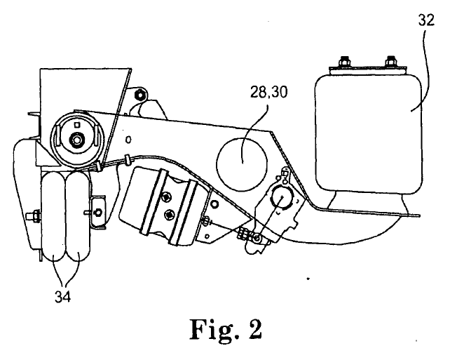

The posterior section 16 of the vehicle 10 includes a set of highway wheels 24,26 each supported to the underside of the support frame 20 via a number of tandem wheel axles 28,30. As can be further seen in FIG. 2, each wheel axle 28,30 is suspended to the vehicle 10 via an air ride suspension bag 32 and number of axle lift air bags 34. The air ride suspension bag 32 is located at or about midway between the wheels 24,26, and acts as an air spring for the suspension system of the vehicle 10. The axle lift air bags 34, in turn, are each located adjacent to a respective wheel 24,26, and serve as an air spring/suspension for providing vertical support to the wheels 24,26. The air ride suspension bag 32 and axle lift air bags 34 may comprise conventional air bags commonly employed as part of the suspension system. As is discussed further herein, the vertical lifting action provided by the axle lift air bags 34 can be further used in conjunction with an articulating rail bogie for transitioning the vehicle 10 for use over a railway.

As further shown in FIG. 1, an axle locking mechanism 36 located on the underside of the support frame 20 towards the posterior section 16 of the vehicle 10 can be configured to secure the wheel axles 28,30 in a retracted position under the vehicle 10 once converted for use in the railway mode. When actuated in a locked position, the axle locking mechanism 36 secures the wheel axles 28,30 in place on the underside of the support frame 20, thus preventing the axles 28,30 from overcoming the force normally provided by the axle lift air bags 34 and inadvertently descending and contacting the ground or rails during railway operations. The axle locking mechanism 36 further ensures that an adequate clearance is maintained between the wheels 24,26 and the rails in the event air pressure is lost within the air bags 32,34.

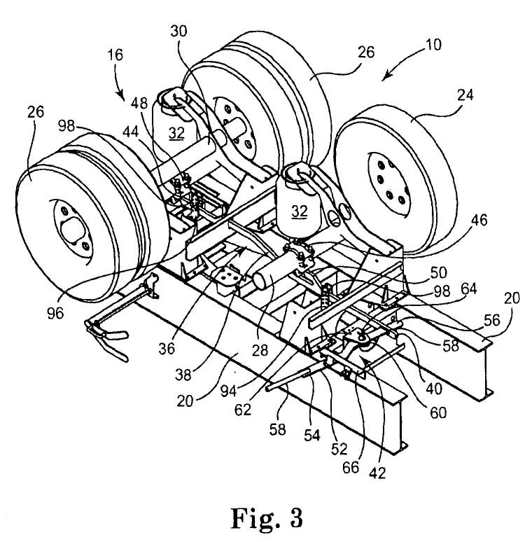

FIG. 3 is a bottom view of the vehicle 10 of FIG. 1 showing the axle locking mechanism 36 located on the underside of the vehicle 10. FIG. 3 may represent, for example, a bottom perspective view of the underside of the vehicle 10, wherein a portion of the suspension system and wheel assembly has been removed to show the features of the axle locking mechanism 36 in greater detail. As can be further seen in FIG. 3, the axle locking mechanism 36 includes a tandem axle lockbar 38 having a first end 40 coupled to a locking lever assembly 42, and extending longitudinally in a direction towards the posterior end of the vehicle 10 to a second end 44 thereof. In the embodiment shown, the lockbar 38 extends along the longitudinal centerline of the vehicle 10 at a location approximately midway between the wheels 24,26.

The lockbar 38 includes a number of support elements 44,50 each adapted to engage a corresponding lockbar support 46,48 for supporting the wheel axles 28,30 in a tucked-away position on the underside of the vehicle 10 during railway operations. A first support element 50 on the lockbar 38 is adapted to engage a first lockbar support 46 coupled to a first tandem wheel axle 28 on the underside of the vehicle 10. The second end 44 of the lockbar 38, in turn, serves as a second support element adapted to engage a second lockbar support 48 coupled to a second tandem wheel axle 30 on the underside of the vehicle 10.

The locking lever assembly 42 is coupled to the lockbar 38 so as to translate a pivoting force applied to the assembly 42 into longitudinal movement of the lockbar 38 between a first, disengaged position and a second, engaged position on the underside of the vehicle 10. In the illustrative embodiment depicted, the locking lever assembly 42 comprises a lockbar lever 52 having a first end 54 and a second end 56. The first end 54 of the lockbar lever 52 is secured to a handle 58. The second end 56 of the lockbar lever 52, in turn, is movably received within a slot 58 on the first end 40 of the lockbar 38.

The lockbar lever 52 can be actuated to move the lockbar 38 longitudinally between a first, unlocked position and a second, locked position, causing the locking bar support elements 44,50 to engage or disengage with the lockbar supports 46,48. The lockbar lever 52 may comprise a horizontally oriented lever that extends outwardly from one side of the vehicle 10 at a location anterior to the wheel axles 28,30. In certain embodiments, for example, the lockbar lever 52 may comprise a class 1 or class 3 lever hingedly coupled about a fulcrum point 60, which translates horizontal motion of the handle 58 into pivotal motion of the second lever end 56. In some embodiments, the lever 52 can be pivotally coupled to a fulcrum gusset 62 via a pin 64 extending through a portion of the lever 52. Other types of lever mechanisms can also be employed, however.

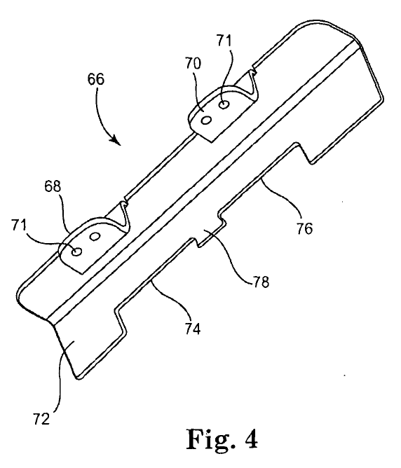

A lever stop mechanism 66 coupled to the vehicle 10 can be used to limit the travel of the lockbar lever 52 during actuation between the first and second positions. As further shown in conjunction with FIG. 4, the lever stop mechanism 66 can include a number of locking tabs 68,70 each including a number of holes 71 adapted to receive a pin (not shown) that is used to limit travel of the lockbar lever 52. A main body 72 of the lever stop mechanism 66 defines a first stop 74 separated by a second stop 76 via a protrusion 78. The first and second stops 74,76 of the main body 72 are each adapted to receive and hold the lockbar lever 52 stationary once engaged in either of the first or second positions. To remove the lockbar lever 52 from within one of the stops (e.g., stop 74), the operator may temporarily pull the handle in a downward direction, causing the lockbar lever 52 to disengage from within the stop 74. Once disengaged, the operator may then pivot the lockbar lever 52 towards the other stop 76 and pull the lever 52 upwardly, causing the lever 52 to engage within the stop 76.

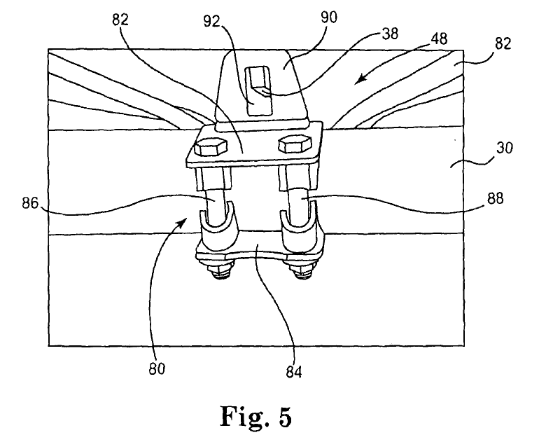

FIG. 5 is a view showing the lockbar support 48 coupled to the second (i.e., posterior) tandem wheel axle 30. As shown in FIG. 5, the lockbar support 48 includes an adjustable clamp 80 formed by a set of upper and lower plates 82,84 attached to the tandem wheel axle 30 via a number of bolts 86,88. The upper plate 82 includes an upwardly extending portion 90 with an opening 92 adapted to receive the second end 44 of the lockbar 38 when extended in a direction substantially parallel to the longitudinal centerline of the vehicle 10. When engaged within the opening 92, the lockbar 38 is supported in a fixed vertical position on the underside of the vehicle 10, which prevents the tandem wheel axle 30 from migrating downwardly during railway operations. A similar configuration can be provided for the lockbar support 46 that receives the other support element 50 on the lockbar 38, thereby fixing the vertical position and preventing downward migration of the other tandem wheel axle 28.

Referring back to FIG. 3, the axle locking mechanism 36 may further include a number of vertical adjustment members 94,96 that can be used to adjust the vertical height of the lockbar 38. A first adjustment member 94 located adjacent to the first support element 50, for example, can be utilized to adjust the vertical positioning of the lockbar 38 near the first tandem wheel axle 28 in order to set the wheel axle 28 at a desired height relative to the railway. A second adjustment member 96, in turn, can be utilized to adjust the vertical positioning of the lockbar 38 near the second tandem wheel axle 30 in order to set the wheel axle 30 at a desired height relative to the railway. Each of the adjustment members 94,96 may include a number of vertically spaced through-holes 98, each of which can be configured to receive a pin to set the vertical level of the lockbar 38. The specific shape of the lockbar 38 can be further configured to provide a desired clearance between the tandem wheel axles 28,30 and the railway.

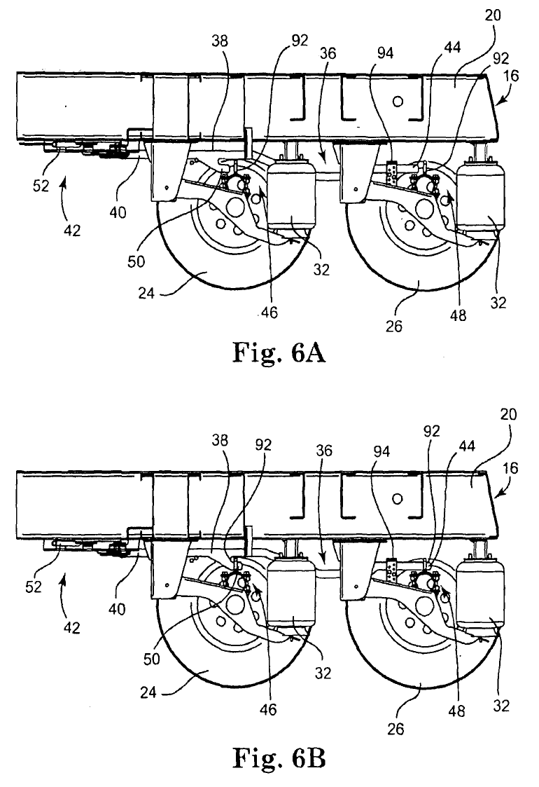

FIGS. 6A-6B are several views showing the actuation of the axle locking mechanism 36 between an unlocked position and a locked position. As depicted in an initial, unlocked position in FIG. 6A, the lockbar lever 52 is shown engaged horizontally in a direction towards the anterior section 14 of the vehicle 10 (i.e., to the left). As the lockbar lever 52 is engaged into this position, the lockbar 38 moves in a direction towards the anterior end of the vehicle 10, causing the support elements 44,50 to disengage from within the openings 92 on the lockbar supports 46,48. In this position, the wheel axles 28,30 are unimpeded vertically by the lockbar 38 and are free to extend downwardly in response to the spring force supplied by the axle lift air bags 34.

To lock the wheel axles 28,30 in a retracted position on the underside of the vehicle 10, the axle lift air bags 34 are inflated and the air ride suspension air bag 32 is exhausted, causing the wheel axles 28,30 to move to their highest position under the vehicle 10. At this time, the axle lift air bags 34 are used to hold the wheel axles 28,30 in place, but are generally dependent on the air pressure to retain this function. During railway operations, the air pressure in the axle lift air bags 34 can later be exhausted such that the lockbar 38 supports the entire load of the wheel axles 28,30.

As further shown in FIG. 6B, the lockbar lever 52 can be pivoted horizontally to the second lever position. In the second lever position, the lockbar 38 moves linearly towards the posterior end of the vehicle 10, causing the support elements 44,50 to engage within the support openings 92. When this occurs, the support elements 44,50 prevent the wheel axles 28,30 from moving vertically underneath the vehicle 10. The load from the wheel axles 28,30 and wheels 24,26 is thus reacted vertically into the support frame 20 of the vehicle 10. If desired, the vertical positioning of the reaction points between the support elements 44,50 and the lockbar supports 46,48 can be adjusted via the adjustment members 94,96 to provide a tighter fit between the lockbar 38 and the openings 92, or to provide for a greater vertical clearance between the wheel axles 28,30 and the railway. The ability to adjust the vertical location of the reaction points may be useful, for example, to minimize the loss in height of the wheel clearance once the vehicle 10 is converted for use in the railway mode.

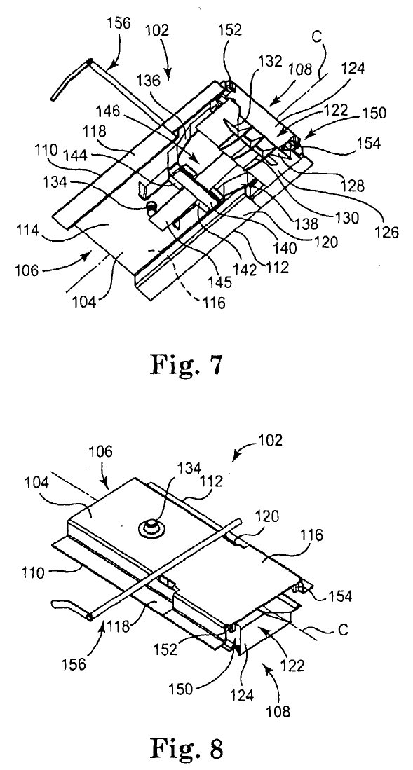

FIGS. 7 and 8 are several views of an illustrative receiver unit 102 configured for use in connecting the posterior section 16 of the vehicle 10 to a rail bogie. As shown in FIGS. 7-8, the receiver unit 102 includes a main body 104 having an anterior end 106, a posterior end 108, a first side 110, a second side 112, a bottom section 114, and a top section 116. The first and second sides 110,112 of the receiver unit 102 extend upwardly from the main body 104, and are bent or oriented outwardly at sections 118,120. The top section 116 of the receiver unit 102 can be attached to the support frame 20 of the vehicle 10 via a number of weld, bolts, and/or other suitable attachment means. In some embodiments, the receiver unit 102 can be fabricated as a separate unit from the vehicle 10, and then attached to the underside of the support frame 20 during manufacturing of the vehicle 10. In certain embodiments, for example, the receiver unit 102 can be provided as part of a kit that can be used to retrofit a tractor trailer for use as a bimodal hauling vehicle. Alternatively, and in other embodiments, the receiver unit 102 can be formed integral with the support frame 20 of the vehicle 10, obviating the need to separately attach the receiver unit 102 to the vehicle 10.

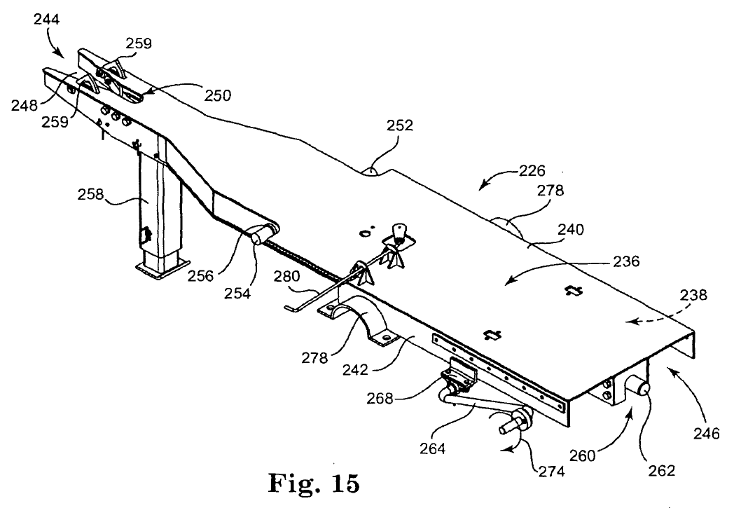

The receiver unit 102 includes a posterior opening 122 adapted to receive the leading end 244 of a spine frame 226 of a rail bogie 224, as further shown and discussed with respect to FIG. 15. The opening 122 is formed by a posterior portion 124 of the main body 104 and a guide member 126 that extends outwardly away from the bottom section 114 of the main body 104. A portion 128 of the guide member 126 is flared outwardly to provide a gradual transition for the leading end 244 of the spine frame 226 as it is initially inserted into the opening 122 and advanced in a direction toward the anterior end 106 of the receiver unit 102. A number of longitudinally oriented ribs 130 and a transversely oriented rib 132 are provided on the guide member 126 to strengthen the receiver unit 102 at or near the location of the opening 122.

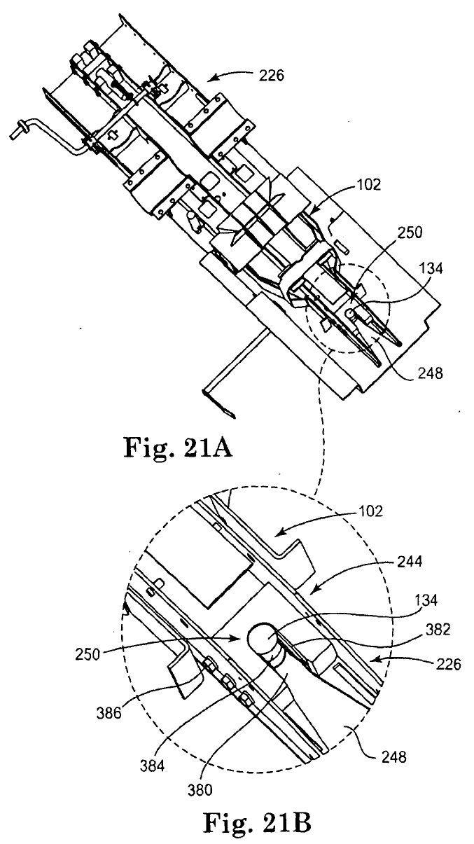

During insertion of the spine frame 226 into the receiver unit 102, a king pin 134 located in a forward portion of the main body 104 is configured to engage within a lock block 250 on the spine frame 226 (see FIGS. 21A-21B), providing a first attachment point for attaching the receiver unit 102 to the rail bogie 224. When coupled to the lock block 250, the king pin 134 is adapted to react vertical forces from the spine frame 226 to the support frame 20 in order to react the load from the rail bogie 224 to the vehicle 10. The king pin 134 further serves to restrain lateral movement of the spine frame 226 within the receiver unit 102.

The leading end 244 of the spine frame 226 can be guided into the receiver unit 102 towards the king pin 134 via a number of contoured guiding members 136,138, which act to ensure proper lateral alignment of the lock block 250 with the king pin 134 during insertion. The lateral guiding members 136,138 may extend from a first location at or near the posterior opening 122, and gradually converge towards each other along the length of the main body 104 towards the anterior end 106 of the receiver unit 102 adjacent to the king pin 136. During insertion, the lateral guiding members 136,138 ensure that the centerline of the spine frame 226 is properly aligned with the king pin 134.

A vertical guiding member 140 that extends downwardly from the bottom section 114 of the main body 104 is configured to facilitate vertical alignment of the leading end 244 of the spine frame 226 upon insertion into the receiver unit 102, thus ensuring that the spine frame 226 lies in a substantially horizontal position adjacent to the bottom section 114 of the main body 104. A number of vertical guiding elements 142,144 coupled to the vertical guiding member 140 are adapted to provide a smooth transition as the spine frame 226 is inserted into the receiver unit 102. A longitudinally oriented guiding member 145 coupled to the main body 104 of the receiver unit 102 and extending longitudinally along the centerline C of the receiver unit 102 can be further used to exert a vertically directed biasing force against the spine frame 226 to ensure that the frame 226 lies in a substantially horizontal position adjacent to the bottom section 114 of the main body 104.

In the illustrative embodiment depicted, the receiver unit 102 may further include a number of voids or openings that permit dirt, snow, ice, and/or other debris to be purged from within the interior space 146 of the receiver unit 102 during insertion of the spine frame 226. In certain embodiments, for example, the voids or openings may expose the interior space 146 of the receiver unit 102 to the surrounding environment on the underside and/or sides of the vehicle 10, which helps to prevent the buildup of debris within the receiver unit 102. Alternatively, and in other embodiments, the interior space 146 within the receiver unit 102 can be devoid of such voids or openings such that the interior space 146 is substantially closed to the surrounding environment.

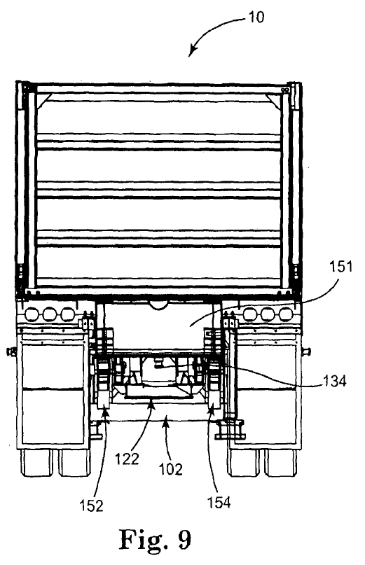

FIG. 9 is a rear view showing the receiver unit 102 coupled to the vehicle 10 of FIG. 1. As further shown in FIG. 9, and in some embodiments, a flap 151 hingedly coupled to the posterior end of the vehicle 10 can be utilized to seal the opening 122 of the receiver unit 102 when the vehicle 10 is operating in the highway mode. During highway use, for example, the flap 151 can be pivoted downwardly to seal the opening 122 of the receiver unit 102 in order to prevent dirt, snow, ice, and/or other debris from entering into the interior space 146 of the receiver unit 102 through the opening 122.

As can be further seen with respect to FIGS. 7-9, a bogie locking mechanism 150 can be utilized for further securing the rail bogie 224, and in particular, the spine frame 226, to several locations on the receiver unit 102. The bogie locking mechanism 150 can include a number of lock jaws 152,154 each located at a respective side 110,112 at or near the posterior end 108 of the receiver unit 102. During attachment of the spine frame 226 to the receiver unit 102, a locking lever mechanism 156 can be engaged by the operator to actuate the lock jaws 152,154 between an unlocked position, allowing movement of several locking pins 252,254 on the spine frame 226 (see FIG. 15) relative to the receiver unit 102, and a locked position, securing the locking pins 252,254 within the lock jaws 152,154 and preventing movement of the spine frame 224 relative to the receiver unit 102. In some embodiments, and as further discussed herein, the engagement of the locking pins 252,254 into the lock jaws 152,154 can be accomplished as the spine frame 226 is inserted into the receiver unit 102, and through a vertical alignment procedure in which the rail bogie 224 is articulated upwardly to align the locking pins 252,254 vertically within the lock jaws 152,154.

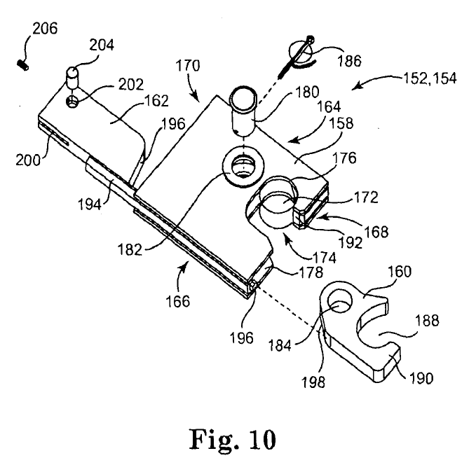

FIG. 10 is an assembly view showing the configuration of one of the lock jaws 152,154 depicted in FIGS. 7-9. As can be further seen in FIG. 10, each lock jaw 152,154 includes a stationary jaw member 158, a pivoting jaw member 160, and a lock jaw wedge 162. The stationary jaw member 158 is fixedly secured to one of the sides 110,112 of the receiver unit 102, and includes a top section 164, a bottom section 166, an anterior end 168, and a posterior end 170. The anterior end 168 of the stationary jaw member 158 includes an opening 172 and an entrance pathway 174 adapted to receive a corresponding locking pin 252,254 on the spine frame 226 during insertion of the frame 226 into the receiver unit 102. The opening 172 is offset vertically a small distance from the entrance pathway 174 such that, during insertion of the spine frame 226 into the receiver unit 102, the locking pin 252,254 initially enters the opening 172 horizontally through the entrance pathway 174, and is then engaged upwardly towards an upper surface 176 of the opening 172 when the spine frame 226 is articulated relative to the vehicle 10, as discussed further herein.

The pivoting jaw member 160 is adapted to pivot within a slot 178 formed within the interior of the stationary jaw member 158 between a first, disengaged position that permits the locking pins 252,254 to be inserted through the entrance pathways 174 and into the openings 172, and a second, engaged position that firmly grips and secures the locking pins 252,254 within the openings 172. Each pivoting jaw member 160 can be configured to pivot about a fulcrum point formed by a pin 180, which extends through a collar 182 on the stationary jaw member 158 and an opening 184 formed through the pivoting lock jaw member 160. A cotter pin 186 is used to secure the pin 180 in place within the collar 182 while allowing the pivoting jaw member 160 to pivot within the slot 178.

The pivoting lock jaw member 160 further includes an interior space 188 and a finger 190. When actuated in the locked position, the finger 190 is configured to pivot and engage a mating surface 192 on the stationary jaw member 158, causing the pivoting lock jaw member 160 to close and tightly grip the locking pins 252,254 within the jaw members 158,160.

The lock jaw wedge 162 is adapted to move linearly along a guide track 194 on the bottom section 166 of the stationary jaw member 158 to pivotally engage the pivoting jaw member 160 between the locked and unlocked positions. A forward stop member 196 located on the guide track 194 at or near the posterior end 168 of the stationary jaw member 158 is adapted to prevent forward movement of the lock jaw wedge 162 beyond the end 168 when the pivoting jaw member 160 is actuated into the locked position. In some embodiments, a rearward stop member located on a rearward portion of the guide track 194 can be used to limit backward movement of the lock jaw wedge 162 during actuation of the pivoting jaw member 160 into the unlocked position.

A sloped surface 196 on the lock jaw wedge 162 is configured to mate with and engage a correspondingly sloped surface 198 on the pivot jaw member 160, which through a camming action, causes the pivoting jaw member 160 to pivot about the pin 180. The rearward portion of the lock jaw wedge 162 includes a slot 200 and an opening 202. The opening 202 is adapted to receive a pin 204 and set-screw 206 that pivotally connects a portion of the locking lever mechanism 156 to the lock jaw wedge 162.

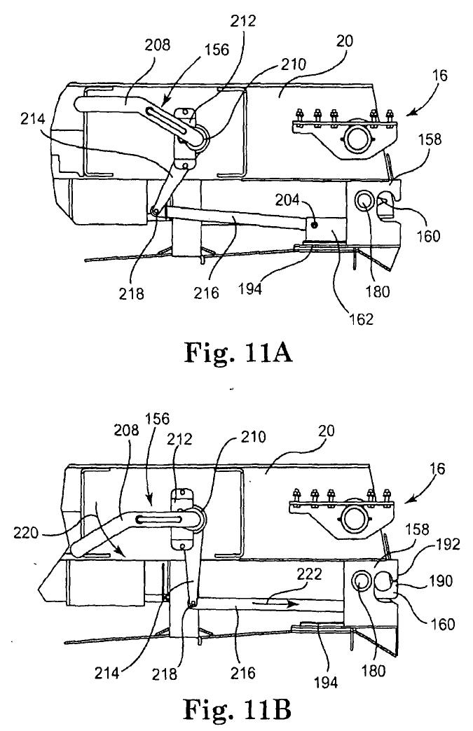

FIGS. 11A-11B are several views showing the actuation of the locking lever mechanism 156 and one of the lock jaws 152,154 in greater detail. As shown in a first, unlocked position in FIG. 11A, the locking lever mechanism 156 includes a handle 208 coupled to an elongated shaft 210 that is rotatably coupled at a joint 212 to the support frame 20 of the vehicle 10. A number of linkages 214,216 are configured to translate rotational motion from the elongated shaft 210 into linear movement of the lock jaw wedge 162 in order to engage or disengage the lock jaw members 158,160 about the locking pins 252,254. The first linkage 214 is fixedly secured at a first end to the elongated shaft 212, and is pivotally coupled at a second, opposite end to the second linkage 216 via a pin 218. The second linkage 216, in turn, is pivotally coupled to the rearward portion of the lock jaw wedge 162 via pin 204.

FIG. 11B is another view showing the locking lever mechanism 156 in a second, locked position for securing the spine frame 226 to the receiver unit 102. As shown in FIG. 11B, pivotal motion of the lever handle 208 in a counterclockwise direction indicated generally by arrow 220 causes the first linkage 214 to pivot and translate the second linkage 216 in a direction towards the posterior end 16 of the vehicle 10, as indicated generally by arrow 222. The translation of the second linkage 216 in this direction 222, in turn, forces the lock jaw wedge 206 to move towards and engage the pivoting jaw member 160, causing the pivoting jaw member 160 to rotate about the fulcrum point provided by the pivot pin 180. When this occurs, the pivoting jaw member 160 pivots upwardly within the stationary jaw member 158 causing the finger 190 to engage the mating surface 192 on the stationary jaw member 158 and secure the locking pins 252,254 within the jaw members 158,160.

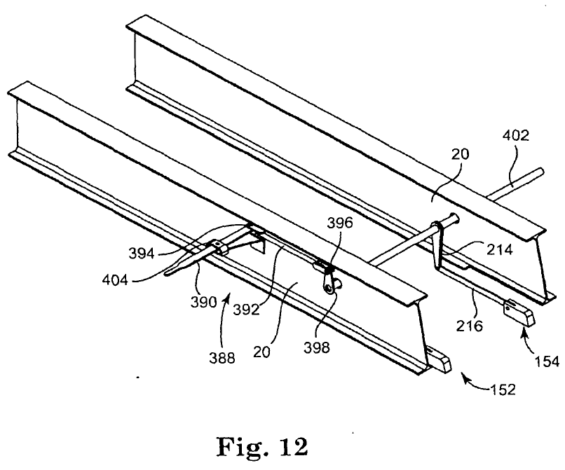

FIG. 12 is a view showing another illustrative embodiment of a locking lever mechanism 388 for use in actuating the lock jaws 152,154. The locking lever mechanism 388 is similar to the locking lever mechanism 150 discussed above with respect to FIGS. 7-9, with like elements labeled in like fashion. In the illustrative embodiment depicted in FIG. 12, however, the locking lever mechanism 388 includes a lever handle 390 pivotally coupled to a connecting rod 392 via a pivot point 394. The connecting rod 392, in turn, is connected at a second pivot point 396 to a lever arm 398, which is secured to an elongated shaft 400 connected to the first linkages 214. The length of the lever arm 398 can be selected so as to provide a mechanical advantage from the lever arm 398 to the elongated shaft 400.

In use, the lever 390 can be engaged a horizontal direction (i.e., to the left or right), causing the lever 390 to pivot about a fulcrum bracket 404 secured to the support frame 20. As this occurs, the connecting rod 392 translates longitudinally, causing the lever arm 398 to rotate the elongated shaft 400. The rotation of the elongated shaft 400 is translated to the linkages 214,216 which either engage or disengage the lock jaw members 158,160 about the locking pins 252,254.

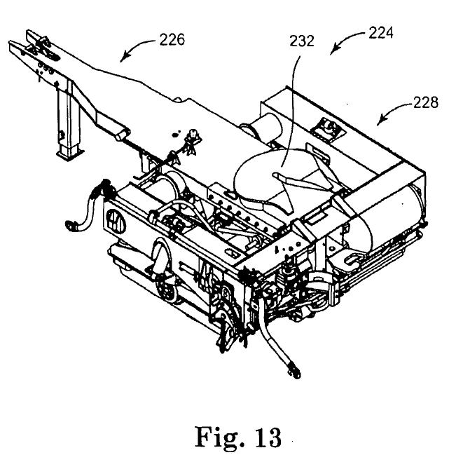

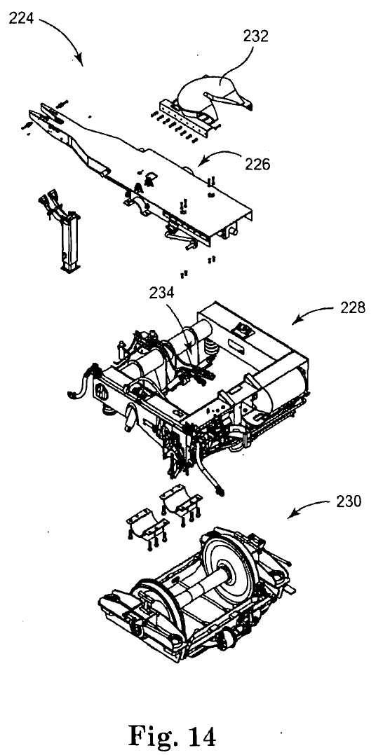

FIGS. 13 and 14 are several views showing an illustrative rail bogie 224 for use in supporting the vehicle 10 of FIG. 1 over a railway. As shown in FIGS. 13-14, the rail bogie 224 includes a spine frame 226, a swing frame 228, and a suspension assembly 230, which together can be used to support the posterior end 16 of the vehicle 10 during railway operations. The spine frame 226 provides a support structure and mechanism for releasably securing the rail bogie 224 to the receiver unit 102. In some embodiments, the spine frame 226 may further include a fifth wheel hitch 232 or other suitable attachment means for securing the rail bogie 224 to another hauling vehicle.

The swing frame 228 includes an articulation mechanism 234 that can be used to raise or lower a portion of the rail bogie 224 to facilitate the connection of the spine frame 226 to the receiver unit 102, and for loading the bogie 224 onto a railway. The swing frame 228 also includes various structure for controlling the operation of the rail bogie 224, including a suspension system for supporting the bogie 224, and a braking system for controlling the suspension assembly 230.

FIG. 15 is a view showing the spine frame 226 in greater detail. As further shown in FIG. 15, the spine frame 226 includes a top section 236, a bottom section 238, a first side 240, second side 242, a leading end 244, and a trailing end 246. The leading end 244 of the spine frame 226 is tapered relative to the trailing end 246, and is contoured to fit through the posterior opening 122 and into the interior space 146 of the receiver unit 102. A V-shaped opening 248 and lock block 250 located at or near the leading end 244 of the spine frame 226 is adapted to receive the king pin 134 on the receiver unit 102, which serves to restrain motion of the spine frame 226 relative to the vehicle 10.

An elongated tube 256 extending across the width of the spine frame 226 can be configured to receive a number of locking pins 252,254 that extend outwardly in a direction away from the sides 240,242 of the spine frame 226. In some embodiments, the elongated tube 256 is welded to the spine frame 226, and is adapted to receive the locking pins 252,254 via a press fit to facilitate replacement of the locking pins 252,254. The locking pins 252,254 are each configured to engage with a corresponding lock jaw 152,154 on the receiver unit 102 for securing the spine frame 226 to the posterior end 108 of the receiver unit 102. A first locking pin 252 extending outwardly from the tube 256 adjacent to the first side 240, for example, is received within a corresponding lock jaw 152 located towards the first side 110 of the receiver unit 102. A second locking pin 254 extending outwardly from the tube 256 adjacent to the second side 242, in turn, is received within a corresponding lock jaw 254 located towards the second side 112 of the receiver unit 102 opposite the first side 110.

As the leading end 244 of the spine frame 226 is inserted into and advanced through the interior space 146, the locking pins 252,254 are configured to enter horizontally through the entrance pathways 174 and into the openings 172 of the stationary jaw members 158. At about the same time, the king pin 134 on the receiver unit 102 engages the lock block 250 on the spine frame 226. Once the locking pins 252,254 are initially inserted into the openings 172, the spine frame 226 can then be raised slightly to align the locking pins 252,254 within the openings 172, as discussed further below. The locking lever mechanism 156 can then be actuated by an operator to engage the pivoting jaw members 160 into the locked (i.e., closed) position. Once engaged in the locked position, the rail bogie 224 is prevented from both vertical and longitudinal movement relative to the receiver unit 102, thus rigidly coupling the rail bogie 224 to the vehicle 10.

The rail bogie 224 can be supported in an upright position above the ground via a kickstand 258, which extends downwardly from the bottom section 238 of the spine frame 226 at a location rearward from the lock block 250. The kickstand 258 is actuatable between an extended position for use when the rail bogie 224 is detached from the vehicle 10 and is not in operation, and a retracted position when the rail bogie 224 is in operation over a railway. In some embodiments, the kickstand 258 is configured to automatically unlock and retract under the spine frame 226 when the leading end 244 of the spine frame 226 is inserted into the receiver unit 102. In certain embodiments, for example, the kickstand 258 can be configured to automatically unlock and retract under the spine frame 226 when a number of tabs 259 extending upwardly from the spine frame 226 are depressed downwardly as the spine frame 226 is inserted into the receiver unit 102.

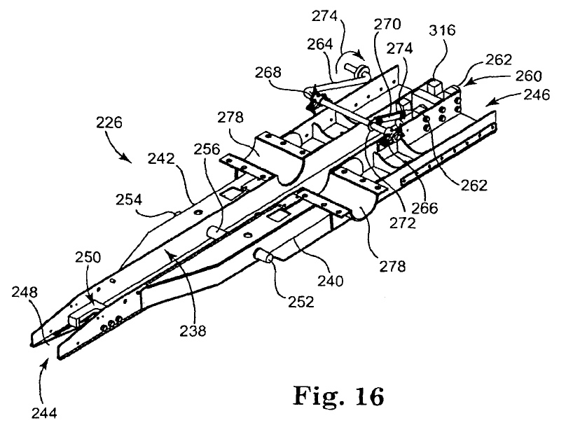

A lock pin mechanism 260 located towards the trailing end 246 of the spine frame 226 opposite the lock block 250 provides a means for preventing articulation of the swing frame 228 relative to the spine frame 226 once the rail bogie 224 is attached to the receiver unit 102 and is configured for use in the railway mode. As can be further seen in a bottom view of the spine frame 226 in FIG. 16, the lock pin mechanism 260 includes a locking pin 262 that can be engaged via a lock pin lever 264. The lock pin lever 264 is pivotally coupled to the bottom section 238 of the spine frame 226 via a number of rotary mounts 266,268, and is coupled to the lock pin 262 via a mechanical linkage 270. The mechanical linkage 270 is coupled at a first end 272 to the lock pin lever 264 and at a second end 274 to the lock pin 262.

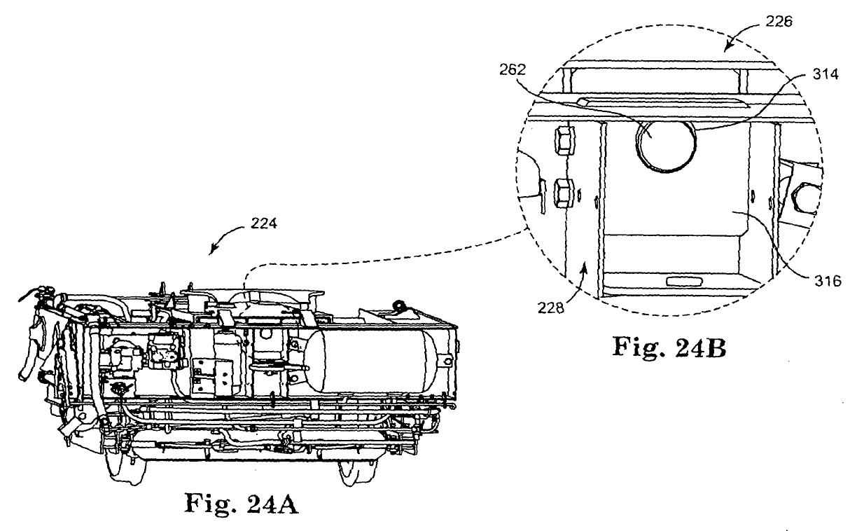

In use, pivotal motion of the lock pin lever 264 in a clockwise direction indicated generally by arrow 276 causes the mechanical linkage 270 to move towards the trailing end 246 of the spine frame 226. Due to the coupling of the mechanical linkage 270, the lock pin 262 is adapted to extend outwardly a short distance away from the trailing end 246 of the spine frame 226. In this extended position, the lock pin 262 is adapted to engage within an opening 314 on the swing frame 228 (see FIG. 24B), thus preventing any articulation of the swing frame 228 relative to the spine frame 226. To disengage the lock pin 262 within the opening 314, the lock pin lever 264 can be pivoted in an opposite (i.e., counterclockwise) direction, causing the mechanical linkage 270 to move towards the leading end 244 of the spine frame 226 and disengage the lock pin 262 from within the opening 314, thus allowing the swing frame 228 to articulate relative to the spine frame 226.

The spine frame 226 further includes a number of U-shaped rotary connection mounts 278, which as discussed in further detail herein, are adapted to receive a pivot tube 298 that permits the swing frame 228 to articulate relative to the spine frame 226. The rotary connection mounts 278 are positioned along the length of the spine frame 226 between the locking pins 252,254 and the lock pin mechanism 260, and are oriented transversely across the width of the spine frame 226 extending outwardly a short distance beyond the sides 240,242. As further shown in FIG. 15, a hydraulic pump lever 280 extending from one side 242 of the spine frame 226 can be used by an operator to actuate a hydraulic pump to either raise or lower the swing frame 228 relative to the spine frame 226, allowing the operator to adjust the angle of the rail bogie 224 relative to the vehicle 10 and/or to lift the rail bogie 224 above the ground or rails.

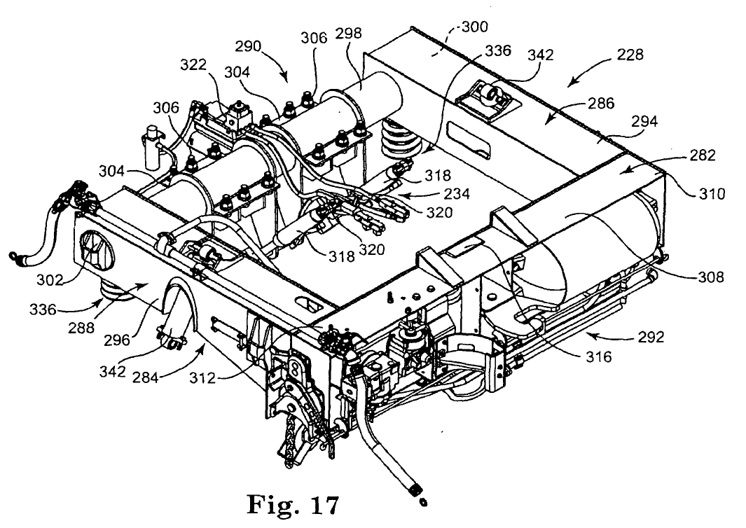

FIG. 17 is a view showing the swing frame 228 in greater detail. As further shown in FIG. 17, the swing frame 228 includes a top section 282, a bottom section 284, a first side 286, a second side 288, a leading end 290, and a trailing end 292. The first and second sides 286,288 each comprise a respective support frame element 294,296 that extends from the leading end 290 to the trailing end 292 of the swing frame 228. A pivot tube 298 located towards the leading end 290 of the swing frame 228 extends transversely between the sides 286,288. A first end 300 of the pivot tube 298 is pivotally coupled via a frictionless rotary connection to the support frame element 294 on the first side 286 of the swing frame 228. A second end 302 of the pivot tube 298, in turn, is pivotally coupled via a frictionless rotary connection to the support frame element 296 on the second side 288 of the swing frame 228.

The pivot tube 298 may be pivotally coupled to the spine frame 226, and in particular to the rotary connection mounts 278, via a pair of collars 304 that mate with the rotary connection mounts 278. Connection of the collars 304 to the rotary connection mounts 278 can be accomplished, for example, using a number of bolts 306. The diameter of the pivot tube 298 is configured such that the pivot tube 298 is securely received within the rotary connection mounts 278 on the spine frame 226 while also allowing the pivot tube 298 to rotate within the mounts 278. The pivot tube 298 interface to the spine frame 226 also provides a lateral restraint between the spine frame 226 and the swing frame 228.

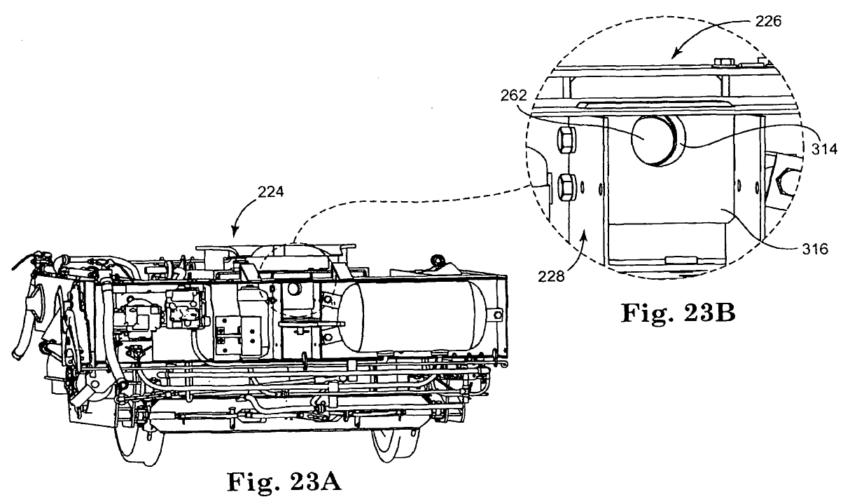

The trailing end 292 of the swing frame 228 includes a transverse frame element 308 having a first end 310 that connects to frame element 294 at side 286, and a second end 312 that connects to frame element 296 at side 288. The transverse frame element 308 includes a pin block 316, which as shown further in FIG. 23B, has an opening 314 that receives the locking pin 262 from the spine frame 226. When the locking pin lever 264 is actuated to engage the locking pin 262 in the extended (i.e., locked) position, the locking pin 262 is adapted to enter the opening 314 in the pin block 316. Once engaged fully within the opening 314, and as further shown in FIGS. 24A-24B, the locking pin 262 prevents the trailing end 292 of the swing frame 228 from articulating about the pivot tube 298. Conversely, when the locking pin 262 is disengaged within the opening 314, and as shown in FIGS. 23A-23B, the trailing end 292 of the swing frame 228 can be articulated relative to the spine frame 226.

Articulation of the swing frame 228 relative to the spine frame 226 can be accomplished via the articulation mechanism 234, which includes a number of hydraulic cylinders 318 and hoses 320 fluidly coupled to an air drive hydraulic pump 322.

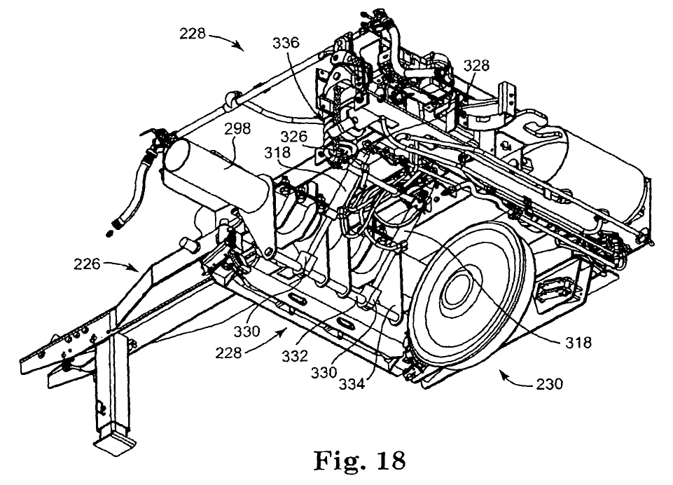

FIG. 18 is a bottom view of the rail bogie 224 in which various components of the swing frame 228 and suspension assembly 230 have been removed to show the articulation mechanism 234 in greater detail. As further shown in FIG. 18, an upper end 326 of each hydraulic cylinder 318 is pivotally connected to a cylinder mount 328 located on the bottom section 238 of the spine frame 226. A lower end 330 of each hydraulic cylinder 318 is attached to a linkage bar 332 and several tear-drop shaped gussets 334, which, in turn, are attached to the pivot tube 298. When hydraulic pressure applied is applied via the hydraulic pump 322, the upper and lower ends 326,330 of the hydraulic cylinders 318 are forced apart from each other, resulting in the application of an upwardly directed force against the spine frame 226 that causes the frame 226 to pivot about the pivot tube 298 and articulate relative to the swing frame 228. The angle at which the hydraulic cylinders 318 are connected to the spine frame 226 can be selected so as to reduce the overall size of the swing frame 228.

As further shown in FIGS. 17-18, the suspension system for the swing frame 228 and suspension assembly 230 can include a number of suspension springs 336 that extend upwardly from the suspension assembly 230 and which function to dissipate the load transferred to the suspension assembly 230. In certain embodiments, each of the suspension springs 336 can include a plurality of nested spring coils. Alternatively, and in other embodiments, each of the suspension springs 336 may comprise a single spring coil. A hydraulic strut 342 coupled to each of the frame elements 294,296 can be further utilized to dissipate the load transferred to the suspension assembly 230. Other components may also be employed as part of the suspension system for the rail bogie 224.

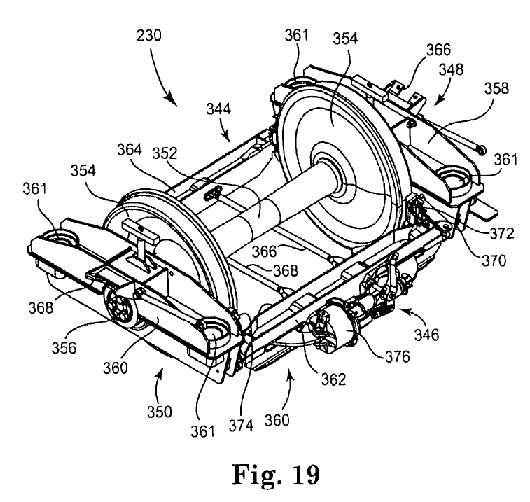

FIG. 19 is a top view showing the suspension assembly 230 in greater detail. As shown in FIG. 19, the suspension assembly 230 has an anterior end 344, a posterior end 346, a first side 348, and a second side 350. A single axle 352 supports a pair of railway wheels 354, and is pivotally connected via a roller bearing 356 at each side 348,350 to a number of longitudinally disposed suspension members 358,360. Each longitudinal suspension member 358,360 includes a set of mounts 361 that receive the lower ends of the suspension springs 336. A joint 366,368 on each suspension member 358,360, in turn, connects to the gas struts 342 extending downwardly from the swing frame 228. Although a single-axle suspension assembly 230 is depicted in FIG. 19, in other embodiments a bi-axle or tri-axle wheel assembly may be used as part of the suspension system for the rail bogie 224.

The suspension assembly 230 may further include a hydraulically operated braking system 360. In the illustrative embodiment depicted, the braking system 360 includes a set of transverse brake beams 362,364 coupled together via a number of rods 366,368. Each of the brake beams 362,364 slide on a number of wear plates 370. The brake beams 362,364 are also coupled to a number of brake pads 372,374 adapted to frictionally engage the wheels 354. During activation, pneumatic pressure from a pneumatic cylinder 376 pulls the rods 366,368 in a direction towards the wheels 354. This action results in the brake beams 362,364 moving together and forcing the brake pads 372,374 to compress and supply the desired braking force to the wheels 354. The configuration of the braking system 360, including the wear plates 370, can be configured to float and move equally against the wheels 354 from both sides 348,350 of the suspension assembly 230.

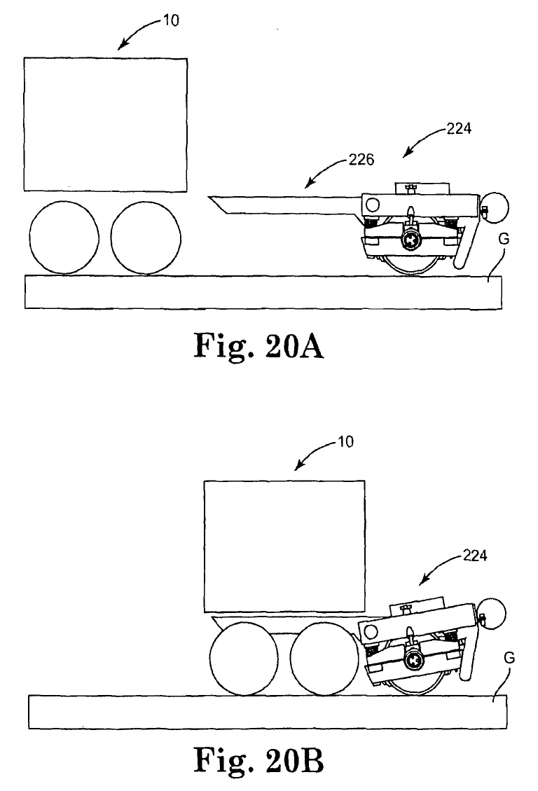

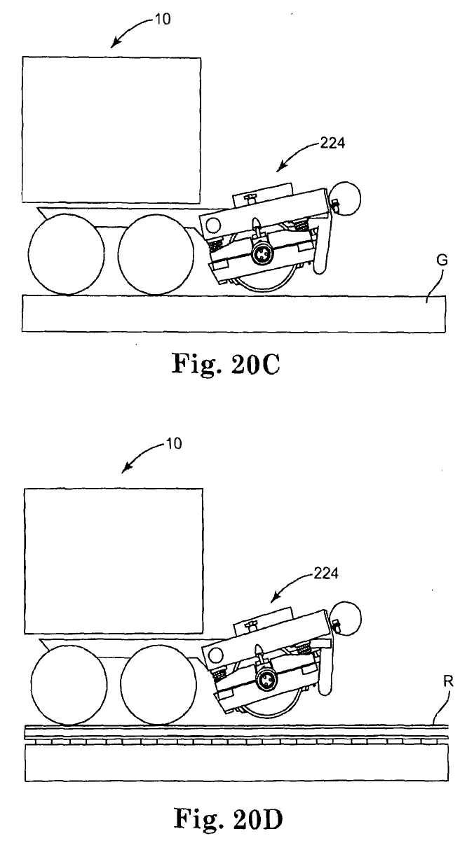

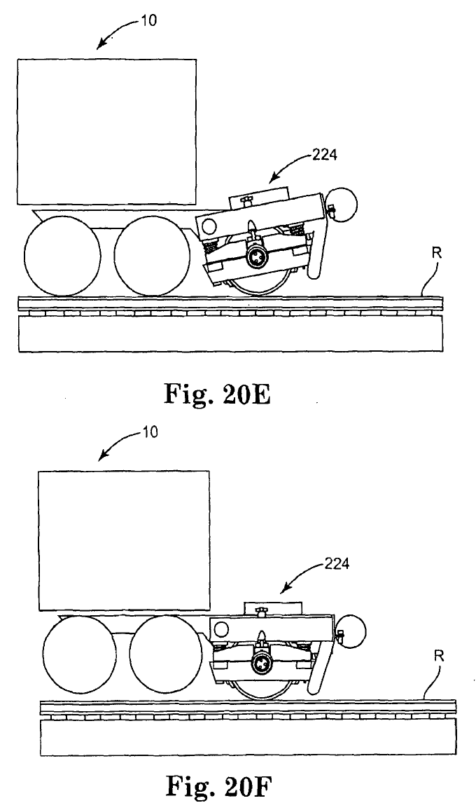

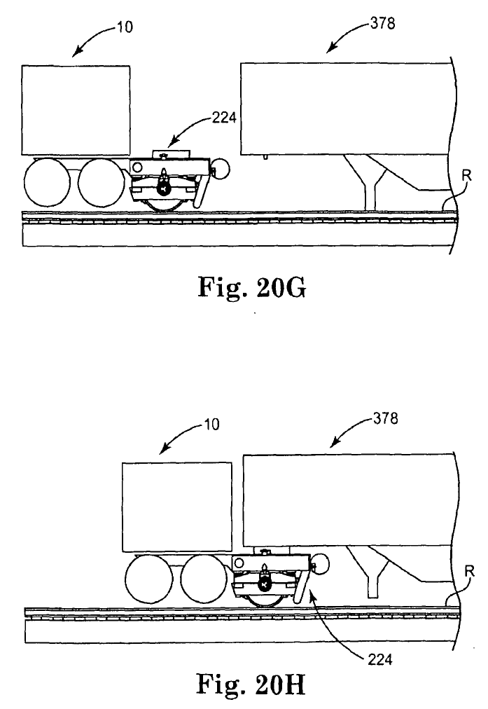

FIGS. 20A-20H are several diagrammatic views illustrating a sequence of steps by which the hauling vehicle 10 of FIG. 1 can be configured for use over a railway using the rail bogie 224. The view depicted in FIGS. 20A-20H may represent, for example, several illustrative steps by which a vehicle 10 initially configured for roadway operation is connected to a rail bogie 224, moved onto a railway, and configured for railway operation. A reverse sequence of steps can be executed to reconfigure the vehicle 10 for roadway use, if desired.

As shown in a first position depicted in FIG. 20A, the rail bogie 224 is initially placed in a vertically upright position such that the leading end 244 of the spine frame 226 is oriented in a substantially horizontal position relative to the ground G. Support of the rail bogie 224 in this position can be accomplished, for example, using the kickstand 258 discussed above with respect to FIG. 15.

To connect the rail bogie 224 to the receiver unit 102, and as further shown in a subsequent step in FIG. 20B, the height of the spine frame 226 is adjusted such that the frame 226 is aligned substantially vertically with the receiver unit 102 on the vehicle 10. In certain embodiments, for example, the height of the spine frame 226 can be adjusted by extending or retracting the hydraulic cylinders 318 of the articulation mechanism 234 discussed above with respect to FIGS. 17-18.

Once the leading end 244 of the spine frame 226 is at the desired height relative to the receiver unit 102, the vehicle 10 is then backed up, causing the leading end 244 of the spine frame 226 to enter the opening 122 of the receiver unit 102. During this step, the leading end 244 of the spine frame 224 contacts the posterior portion 124 of the main body 104 and is deflected upwardly a slight distance as the leading end 244 is forced into the interior space 146 of the receiver unit 102. As this occurs, the lateral guiding members 136,138 within the receiver unit 102 serve to laterally align the V-shaped opening 248 and lock block 250 with the king pin 134. The vertical guiding member 140, including the vertical guiding elements 142,144 and the longitudinally oriented guiding member 145 further transition the leading end 244 of the spine frame 226 vertically into the interior space 146 such that the spine frame 226 is oriented horizontally adjacent to the bottom section 114 of the main body 104.

When the leading end 244 of the spine frame 226 is inserted into the receiver unit 102, the king pin 134 is adapted to engage the lock block 250. Furthermore, during insertion the locking pins 252,254 also enter horizontally through the entrance pathways 174 and into the openings 172 of the stationary jaw members 158. Once positioned within these openings 172, the hydraulic cylinders 118 are then extended a short distance in order raise the locking pins 252,254 towards the upper surface 176 of each of the openings 172. The lever mechanism 156 for the bogie locking mechanism 150 can then be actuated to the locked position in order to secure the locking pins 252,254 in place within the lock jaw members 158,160.

Once the rail bogie 224 is coupled to the receiver unit 102 and the king pin 134 and bogie locking mechanism 150 are locked into position, the operator next retracts the hydraulic cylinders 118, causing the suspension assembly 230 to lift upwardly a short distance above the ground G, as further shown in FIG. 20C. With the suspension assembly 230 in a lifted position, the vehicle 10 can then be relocated to a position over a railway R, as further shown in FIG. 20D. The hydraulic cylinders 118 can be further retracted within a certain range if additional vertical clearance between the frame 230 and the railway R is desired as the rail bogie 224 is moved into position over the railway R.

Once positioned over the railway R, and as shown further in FIG. 20E, the hydraulic cylinders 118 can then be extended to lower the suspension assembly 230 over the railway R. Once the suspension assembly 230 is positioned onto the railway R, the hydraulic cylinders 118 may be further extended, causing the rail bogie 224 to lift the vehicle 10 above the railway R, as further shown in FIG. 20F. The lock pin mechanism 260 can then be engaged in the locked position to lock the spine frame 226 to the swing frame 228. This can be accomplished, for example, by actuating the lock pin lever 264, which translates pivotal motion of the lever 264 into linear motion of the lock pin 262 into the opening 314 of the pin lock block 316.

Once the rail bogie 224 is lowered onto the railway R, the highway wheel axles 28,30 for the vehicle 10 can then be lifted and locked into position on the underside of the vehicle 10 using the axle locking mechanism 36 described above with respect to FIGS. 3-6. In certain embodiments, for example, the wheel axles 28,30 can be moved to their highest position on the underside of the vehicle 10 by inflating the axle lift air bags 34 and exhausting the air ride suspension bags 32, and then pivoting the lockbar lever 52 to engage the support elements 44,50 within the openings 92 of the lockbar supports 46,48 to secure the wheel axles 28,30 in place. The axle lift air bags 34 can then remain in an inflated position as the vehicle is operated in the railway mode. If in the event the axle lift air bags 34 lose pressure, the support elements 44,50 alone can be used to support the weight of the wheel axles 28,30 and wheels 24,26 during railway operations.

With the rail bogie 224 rigidly coupled to the vehicle 10, the vehicle 10 can then be coupled to an adjacent consist 378, as further shown in FIGS. 20G-20H. In some embodiments, for example, the rail bogie 224 can be connected to another hauling vehicle or a railcar using the fifth wheel hitch 232 or other suitable attachment means. In some embodiments, multiple rail bogies 224 can be used to convert a series of bimodal hauling vehicles 10 for use over the railway R.

FIG. 21A-21B are several views showing the attachment of the receiver unit king pin 134 within the lock block 250 of the spine frame 226. As shown in FIGS. 21A-21B, when the leading end 244 of the spine frame 226 is inserted into the receiver unit 102, the king pin 134 is advanced through the V-shaped opening 248 and into the interior space 380 of the lock block 250. A number of tapered ribs 382 extending inwardly within the interior space 380 are adapted to engage an annular slot 384 on the king pin 134. In this position, the king pin 134 reacts vertical and lateral forces from the spine frame 226 through several bolts 386 connecting the lock block 250 to the spine frame 226.

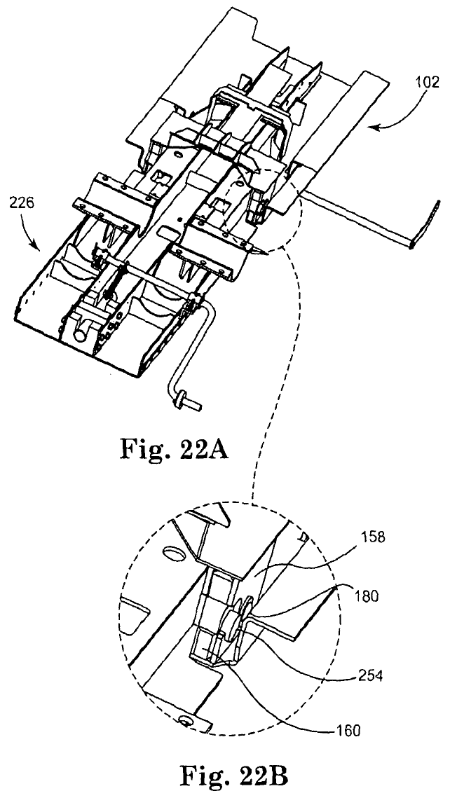

FIGS. 22A-22B are several views showing the engagement of the locking pins 252,254 within the jaw members 158,160 of the receiver unit 102. As can be further seen with respect to FIGS. 22A-22B, the jaw members 158,160 tightly grip the locking pins 252,254, thus rigidly coupling the spine frame 226 to the vehicle 10. This allows the rail bogie 224 to be later lifted off of the ground to facilitate loading or unloading of the rail bogie 224 over the railway, and prevents the rail bogie 224 from disconnecting from the vehicle 10 during railway operations.

FIGS. 23A-24B are several views showing the actuation of the locking pin 262 within the opening 314 of the swing frame 228. As shown in an initial, unlocked position depicted in FIGS. 23A-23B, the locking pin 262 is disengaged from within the opening 314 on the pin lock block 316. In this position, the bogie spine frame 226 is unrestrained from pivoting relative to the bogie swing frame 228, allowing the operator to adjust the angle of the spine frame 226 relative to the swing frame 228. To secure the spine frame 226 to the swing frame 228, the operator pivots the lock pin lever 264 in a counter-clockwise direction, causing the locking pin 262 to extend outwardly and into the opening 314 on the pin lock block 316. As shown in a second, locked position in FIGS. 24A-24B, the positioning of the locking pin 262 within the opening 314 prevents the spine frame 226 from articulating relative to the swing frame 228.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

What is claimed is:

1. A system for connecting a rail bogie to a bimodal hauling vehicle, the system comprising:
a rail bogie adapted to support a bimodal hauling vehicle over a railway, the rail bogie including a frame and a suspension assembly; and
a receiver unit coupled to the vehicle and including a main body having an anterior end, a posterior end, a top section, and a bottom section, the posterior end of the receiver unit including a receiver opening adapted to receive a leading end of the rail bogie frame.

2. The system of claim 1, wherein the receiver unit includes a king pin and a bogie locking mechanism adapted to releasably secure the rail bogie frame to the receiver unit, the bogie locking mechanism including a plurality of lock jaws each actuatable between an unlocked position and a locked position.

3. The system of claim 2, wherein each lock jaw includes a stationary jaw member, a pivoting jaw member pivotally coupled to the stationary jaw member, and a lock jaw actuator coupled to a lever mechanism and adapted to engage the pivoting jaw member between the unlocked position and the locked position.

4. The system of claim 3, wherein each lock jaw actuator includes a lock jaw wedge.

5. The system of claim 4, wherein the lock jaw wedge includes a sloped surface adapted to mate with and engage a sloped surface on the pivoting jaw member through a camming action.

6. The system of claim 3, wherein the rail bogie frame includes a number of locking pins, and wherein the pivoting jaw members are adapted to grip the locking pins when engaged in the locked position.

7. The system of claim 3, wherein the stationary jaw member includes a guide track adapted to slidably receive the lock jaw actuator.

8. The system of claim 7, wherein the guide track includes at least one stop member for limiting movement of the lock jaw actuator along the guide track.

9. The system of claim 3, wherein the bogie locking mechanism includes a lever operatively coupled to an elongated shaft, and a number of linkages configured to translate rotary motion from the elongated shaft into linear movement of the lock jaw actuator.

10. The system of claim 2, wherein the receiver unit includes at least one contoured guiding member adapted to facilitate insertion of the rail bogie frame into the receiver unit.

11. The system of claim 10, wherein the at least one contoured guiding member includes one or more vertical guiding members adapted to align the rail bogie frame in a substantially horizontal position adjacent to the bottom section of the main body.

12. The system of claim 10, wherein the at least one contoured guiding member includes one or more lateral guiding members adapted to align the rail bogie frame with the king pin.

13. The system of claim 1, wherein the receiver unit opening includes a flared guide member.

14. The system of claim 2, wherein the rail bogie frame includes a lock block adapted to receive the king pin.

15. The system of claim 1, further comprising an axle locking mechanism adapted to engage a number of tandem wheel axles of the vehicle between an unlocked position and a locked position.

16. The system of claim 15, wherein the tandem axle locking mechanism includes a tandem axle lockbar coupled to a locking lever assembly, the tandem axle lockbar including a number of support elements adapted to engage a corresponding lockbar support on each tandem wheel axle.

17. A receiver unit for use in a convertible railway-roadway system to connect the frame of a rail bogie to a bimodal hauling vehicle, the receiver unit comprising:
main body having an anterior end, a posterior end, a top section, a bottom section, and an interior space, the posterior end of the receiver unit including a flared receiver opening; and
at least one contoured guiding member adapted to facilitate insertion of the rail bogie frame into the interior space of the receiver unit.

18. The receiver unit of claim 17, wherein the receiver unit further includes:
a king pin coupled to the main body and extending into the interior space of the receiver unit; and
a bogie locking mechanism adapted to releasably secure the receiver unit to a number of locking pins on the rail bogie frame, the bogie locking mechanism including a plurality of lock jaws each actuatable between an unlocked position and a locked position.

19. The receiver unit of claim 18, wherein each lock jaw includes a stationary jaw member, a pivoting jaw member pivotally coupled to the stationary jaw member, and a lock jaw actuator coupled to a locking lever mechanism and adapted to engage the pivoting jaw member between the unlocked position and the locked position.

20. The receiver unit of claim 19, wherein each lock jaw actuator includes a lock jaw wedge.

21. The receiver unit of claim 20, wherein the lock jaw wedge includes a sloped surface adapted to mate with and engage a sloped surface on the pivoting jaw member.

22. The receiver unit of claim 19, wherein the stationary jaw member includes a guide track adapted to slidably receive the lock jaw actuator.

23. The receiver unit of claim 22, wherein the guide track includes at least one stop member for limiting movement of the lock jaw actuator along the guide track.

24. The receiver unit of claim 19, wherein the bogie locking mechanism includes a handle coupled to an elongated shaft, and a number of linkages configured to translate rotary motion from the elongated shaft into linear movement of the lock jaw actuator.

25. The receiver unit of claim 17, wherein the at least one contoured guiding member includes one or more vertical guiding members adapted to align the rail bogie frame in a substantially horizontal position adjacent to the bottom section of the main body.

26. The receiver unit of claim 18, wherein the at least one contoured guiding member includes one or more lateral guiding members adapted to align the rail bogie frame with the king pin.

27. A bimodal trailer for use in a convertible railway-roadway system, the trailer comprising:
a trailer body having an anterior section and a posterior section, and a support frame; and
a receiver unit coupled to support frame at or near the posterior section of the trailer body, the receiver unit including:
a main body having an anterior end, a posterior end, and an interior space, the posterior end of the receiver unit including a flared receiver opening; and
at least one contoured guiding member adapted to facilitate insertion of a rail bogie frame into the interior space of the receiver unit.

28. A rail bogie for use with a bimodal hauling vehicle, the rail bogie including:
a rail bogie frame having a leading end and a trailing end; and
wherein the leading end of the rail bogie frame is tapered relative to the trailing end and includes an opening and a lock block adapted to receive a king pin of the bimodal hauling vehicle, the lock block including at least one rib adapted to engage a slot on the king pin.

29. A method of converting a hauling vehicle for use over a railway using a rail bogie having a frame with a number of locking pins, the method comprising:
inserting a leading end of the rail bogie frame into an opening of a receiver unit coupled to a hauling vehicle, the receiver unit including a king pin and a bogie locking mechanism configured to releasably secure the receiver unit to the rail bogie, the bogie locking mechanism including a plurality of lock jaws each actuatable between an unlocked position and a locked position about the locking pins;
engaging the king pin within a lock block on the rail bogie frame;
adjusting the height of a portion of the rail bogie relative to the receiver unit to align the locking pins vertically within an opening of the lock jaws;
actuating the bogie locking mechanism to the locked position about the locking pins;
raising the rail bogie above the ground and moving the hauling vehicle and rail bogie onto a railway; and
lowering the rail bogie onto the railway.

30. The method of claim 29, wherein the receiver unit opening includes a flared guiding member, and wherein during insertion of the leading end of the rail bogie frame into the receiver unit opening, the leading end of the rail bogie frame is initially deflected upwardly within an interior space of the receiver unit.

31. The method of claim 29, wherein each lock jaw includes a stationary member, a pivoting jaw member pivotably coupled to the stationary jaw member, and a lock jaw actuator coupled to a locking lever mechanism.

32. The method of claim 31, wherein the locking lever mechanism includes a lever handle, and wherein actuating the bogie locking mechanism to the locked position includes rotating the lever handle from a first position to a second position.

33. The method of claim 29, wherein the receiver unit includes at least one contoured guiding member adapted to facilitate insertion of the rail bogie frame into the receiver unit.

34. The method of claim 33, wherein the at least one contoured guiding member includes one or more lateral guiding members, and wherein, during insertion of the leading end of the rail bogie frame into the receiver unit, the one or more lateral guiding members are adapted to align the king pin laterally with the lock block.

35. The method of claim 33, wherein the at least one contoured guiding member includes one or more vertical guiding members, and wherein, during insertion of the leading end of the rail bogie frame into the receiver unit, the one or more vertical guiding members are adapted to align the leading end of the rail bogie frame in a substantially horizontal position within an interior space of the receiver unit.

36. The method of claim 29, wherein the rail bogie is rigidly coupled to the receiver unit upon actuating the bogie locking mechanism to the locked position about the locking pins.

37. The method of claim 29, further comprising securing a number of tandem wheel axles in a fixed vertical position under the vehicle after lowering the rail bogie onto the railway.

38. The method of claim 37, wherein securing a number of tandem wheel axles of the vehicle in a fixed position under the vehicle is accomplished using a tandem axle locking mechanism.

39. The method of claim 38, wherein the tandem axle locking mechanism includes a tandem axle lockbar coupled to a locking lever assembly, the tandem axle lockbar including a number of support elements each adapted to engage a corresponding lockbar support on each tandem wheel axle.

40. The method of claim 29, further comprising coupling the rail bogie to another hauling vehicle after the rail bogie is lowered onto the railway.
